(19) United States
(12) Patent Application Publication
(10) Pub. No.: US 2013/0059627 A1
(43) Pub. Date: Mar. 7, 2013

(54) WIRELESS MOBILE TERMINAL DEVICE

(71) Applicant: Moriaki KIYOMOTO, Kunitachi (JP)

(72) Inventor: Moriaki KIYOMOTO, Kunitachi (JP)

(73) Assignee: FUJITSU MOBILE COMMUNICATIONS LIMITED, Kawasaki-shi (JP)

(21) Appl. No.: 13/589,265

(22) Filed: Aug. 20, 2012

(30) Foreign Application Priority Data
Sep. 2, 2011 (JP) 2011-191298

(51) Int. Cl. H04W 88/06

(52) U.S. Cl. 455/552.1

(57) ABSTRACT

A wireless mobile terminal device including: a position data detector that detects position data; a wireless communication system type data detector that detects wireless communication system type data or relation data; a memory that accumulates the position data and the wireless communication system type data or the relation data in association with each other; a memory controller that autonomously and sequentially stores the position data and the wireless communication system type data or the relation data into the memory; and a wireless communication system type data retriever that selects, upon receipt of current position data, wireless communication system type data of the current position or relation data through adaptive retrieval of a plurality of pieces of the position data and the wireless communication system type data or the relation data in association with each other. This configuration efficiently selects a wireless communication system.

### CROSS-REFERENCE TO RELATED APPLICATIONS

This application is based upon and claims the benefit of priority of the prior Japanese Patent Application No. 2011-191298, filed on Sep. 2, 2011, the entire contents of which are incorporated herein by reference.

### FIELD

The embodiment discussed herein is related to a wireless mobile terminal device and more particularly directed to a wireless mobile terminal device that can use two or more wireless communication systems.

### BACKGROUND

Some wireless mobile terminal devices nowadays are capable of communicating in various communication systems such as Wireless Fidelity (Wi-Fi), Worldwide Interoperability for Microwave Access (WiMAX), and femto, in addition to 3rd Generation-CDMA (3G-CDMA) network such as Code Division Multiple Access (CDMA) 2000, and Wideband-CDMA (W-CDMA). The users of such devices can be benefitted from a wide variety of services.

On the other hand, use of such devices has the following problems.

The above wireless mobile terminal device capable of using various wireless communication systems retrieves an obtainable wireless communication system from all the candidates for a wireless communication system (i.e., carrying out system search on all the candidates), which increases the time for retrieving. Consequently, it takes a long time until the wireless mobile terminal device is ready to wait in a particular communication system. In addition, such retrieving manner depletes the battery power of the wireless mobile terminal device.

There are provided, for such a wireless mobile terminal device communicable in two or more communication systems, a method of searching for an obtainable communication system through retrieving in order previously programmed, and a method of setting a communication system to be used from an operation by the user.

However, in retrieving a communicable in order previously programmed, even when the wireless mobile terminal device is out of service areas and does not receive a service from a particular communication system, the communication service is retrieved in prefixed preferential order, so that it inefficiently takes a long time to obtain usable service.

In setting a communication system to be used from a user operation, the user is needed to grasp change in service areas that the user desires to use, in addition to operation for the setting.

Besides, there is proposed, for a wireless mobile terminal device communicable in two or more communication systems, a method of retrieving a communication system to be used on the basis of a position and a moving speed of the wireless mobile terminal device (see the following Patent Literature 1).

### [Patent Literature 1] Japanese Laid-open Patent Publication No. 2001-309445

The method disclosed in the above Patent Literature has to store data related to all the usable communication systems in a database in advance.

This method takes a long time for system search because an obtainable system is searched for through retrieving from all the usable communication systems.

### SUMMARY

According to an aspect of the embodiment, a wireless mobile terminal device capable of using two or more wireless communication systems, including: a position data detector that detects position data representing a position of the wireless mobile terminal device; a wireless communication system type data detector that detects wireless communication system type data representing a wireless communication system being used by the wireless mobile terminal device or relation data related to the wireless communication system type data; a memory that accumulates the position data detected by the position data detector and the wireless communication system type data or the relation data detected by the wireless communication system type data detector in association with each other; a memory controller that autonomously and sequentially stores the position data and the wireless communication system type data or the relation data into the memory; and a wireless communication system type data retriever that selects, upon receipt of current position data representing a current position of the wireless mobile terminal device, wireless communication system type data of the current position of the wireless mobile terminal device or relation data related to the wireless communication system type data of the current position through adaptive retrieval of a plurality of pieces of the position data and a plurality of pieces of the wireless communication system type data or the relation data in association with each other, which are autonomously and sequentially stored by the memory controller and which are accumulated in the memory.

According to another aspect of the embodiment, a method for retrieving wireless communication system in a wireless mobile terminal device capable of using two or more wireless communication systems, the method including: detecting position data representing a position of the wireless mobile terminal device; detecting the wireless communication system type data representing a wireless communication system being used by the wireless mobile terminal device or relation data related to the wireless communication system type data; autonomously and sequentially storing the position data and the wireless communication system type data or the relation data into a memory included in the wireless mobile terminal device in association with each other; and upon receipt of current position data representing a current position of the wireless mobile terminal device, selecting wireless communication system type data of the current position of the wireless mobile terminal device or relation data related to the wireless communication system type data of the current position through adaptive retrieval of a plurality of pieces of the position data and a plurality of pieces of the wireless communication system type data or the relation data in association with each other, which are autonomously and sequentially stored in the memory.

According to an additional aspect of the embodiment, a computer-readable recording medium having stored therein a program for instructing a computer to execute a process including: autonomously and sequentially storing position data of a wireless mobile terminal device capable of using two or more wireless communication systems and wireless communication system type data representing a wireless communication system being used by the wireless mobile terminal device or relation data into a memory included in the wireless mobile terminal device in association with each other; and upon receipt of current position data representing a current position of the wireless mobile terminal device, selecting wireless communication system type data of the current position of the wireless mobile terminal device or relation data related to the wireless communication system type data of the current position through adaptive retrieval of a plurality of pieces of the position data and a plurality of pieces of the wireless communication system type data or the relation data in association with each other, which are autonomously and sequentially stored in the memory.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a block diagram schematically depicting an example of the hardware configuration of wireless mobile terminal device according to a first embodiment;

FIG. 2 is a diagram functionally depicting the CPU of FIG. 1;

FIG. 3 is a diagram illustrating an example of area configurations of respective communication systems;

FIG. 4 is a table denoting an example of a structure of data stored in a database.

FIGS. 5A and 5B are diagrams depicting examples of display on a monitor;

FIG. 6 is a diagram depicting an example of records overlying a map;

FIG. 7 is a flow diagram denoting a succession of procedural steps of selecting a communication system in wireless mobile terminal device;

FIG. 8 is a table denoting an example of a structure of data accumulated in a database; and

FIG. 9 is a diagram schematically illustrating an example of configuration of a wireless mobile terminal device according to a first modification.

### DESCRIPTION OF EMBODIMENT(S)

Hereinafter, an embodiment of the present invention will now be described with reference to the accompanying drawing. However, it should be noted that the following embodiment is an example, and there is no intention to exclude modifications and application of techniques that are not mentioned in the following embodiment and a modification thereof. In other words, the following embodiment and modification can be changed or modified without departing from the concept of the present invention.

### (1) First Embodiment

(1.1) Configuration of a Wireless Mobile Terminal:

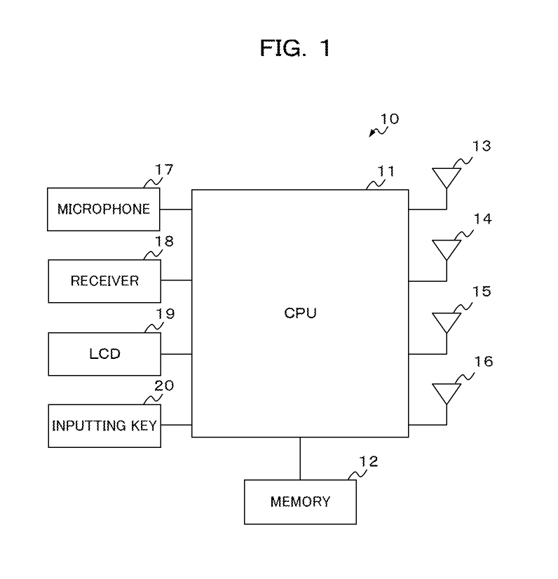

FIG. 1 is a block diagram schematically illustrating an example of the hardware configuration of a wireless mobile terminal device according to the first embodiment.

The wireless mobile terminal device 10 of FIG. 1 exemplarily includes a Central Processing Unit (CPU) 11 that carries out various controls and calculations; a memory 12 that stores data and programs used by the wireless mobile terminal device 10; sending/receiving antennas 13-16; a microphone 17; a receiver 18; a Liquid Crystal Display (LCD) 19 serving an example of a monitor; and an inputting key 20. The receiving antennas 13-16 are respectively provided for a Code Division Multiple Access (CDMA) protocol module 27, a Worldwide Interoperability for Microwave Access (WiMAX) protocol module 28, a Long Term Evolution (LTE) protocol module 29, and a Global Positioning System (GPS) module 30 that are to be detailed below.

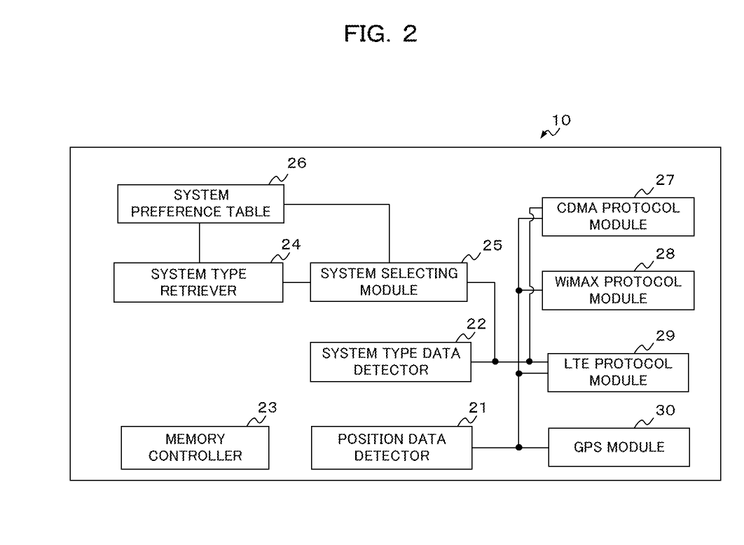

FIG. 2 is a diagram functionally depicting the CPU of FIG. 1. The entire part of the functional configuration of FIG. 2 is also referred to as the wireless mobile terminal device 10 unless a contradiction arises.

The wireless mobile terminal device 10 of FIG. 2 exemplarily includes a position data detector 21, a system kind data detector 22, a memory controller 23, a system kind retriever 24, a system selecting module 25, a system preference table 26, the CDMA protocol module 27, the WiMAX protocol module 28, the LTE protocol module 29, and the GPS module 30.

The CDMA protocol module 27, the WiMAX protocol module 28, and the LTE protocol module 29 perform protocol processing of the respective corresponding communication systems. Examples of protocol processing are encoding and modulating, and decoding and demodulating.

The GPS module 30 measures a current position of the wireless mobile terminal device 10 or a position of a base station that the wireless mobile terminal device 10 is being communicating with using a GPS.

The position data detector 21 obtains position data representing the current position of the wireless mobile terminal device 10. The position data contains, for example, data of the latitude and longitude that can specify the position of the wireless mobile terminal device 10. In other words, the position data detector 21 serves to function as an example of a position data detector that detects the position data of the wireless mobile terminal device 10.

The position data is obtained from a communication system that the wireless mobile terminal device 10 is currently using. For example, a CDMA system can use data of the latitude and longitude included in notification data from the network. In the example of FIG. 2, the position data detector 21 obtains data of the latitude and longitude via the CDMA protocol module 27, the WiMAX protocol module 28, or the LTE protocol module 29.

When position data is not passively obtained from the CDMA protocol module 27, the WiMAX protocol module 28, or the LTE protocol module 29, the wireless mobile terminal device 10 may obtain the position data by means of the GPS function installed in the wireless mobile terminal device 10. Specifically, the CDMA protocol module 27, the WiMAX protocol module 28, and the LTE protocol module 29 are each coupled to the GPS module 30, so that the modules 27, 28, and 29 can obtain the position data from the GPS module 30 anytime.

Alternatively, the position data detector 21 may obtain the position data directly from the GPS module 30.

The system kind data detector 22 detects wireless communication system type data representing one or more wireless communication systems through which the wireless mobile terminal device 10 can communicate. For the above, the system kind data detector 22 serves to function as an example of a wireless communication system type data detector that detects wireless communication system type data that the wireless mobile terminal device 10 is being used or relation data related to the wireless communication system type data.

Here, the memory 12 of FIG. 1 accumulates data (hereinafter also called a record) associating the position data and the wireless communication system type data with each other. Namely, the memory 12 serves to function as an example of a memory that accumulates the position data of the wireless mobile terminal device detected by the position data detector and the wireless communication system type data or the relation data detected by the wireless communication system type data detector in association with each other.

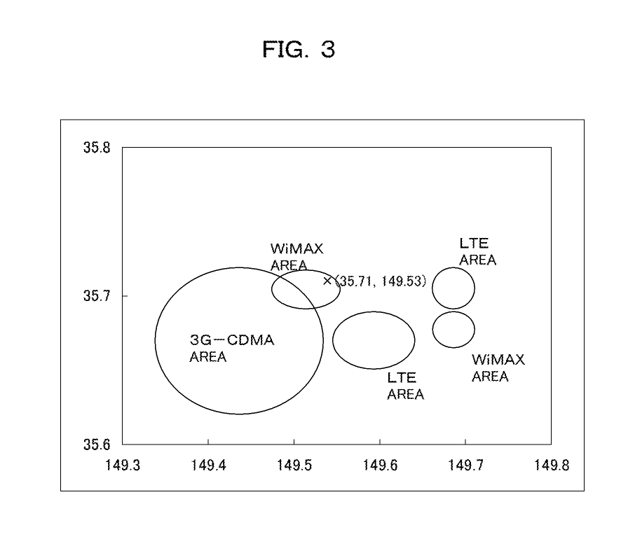

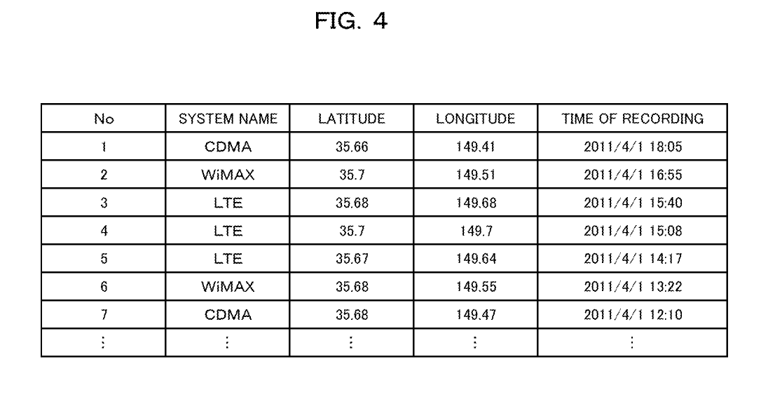

FIG. 3 is a diagram illustrating an example of area configurations of respective communication systems; and FIG. 4 is a table denoting an example of a structure of data stored in a database in the memory 12, which corresponds to the area configurations illustrated in FIG. 3.

As denoting in FIG. 4, the memory 12 accumulates at least the wireless communication system type data and the position data.

Storing also time when each record is stored, the memory 12 can be well maintained by, for example, deleting a record when a predetermined time elapses from the storing. The above time may be replaced by a time elapses from a reference time.

The records accumulated in the memory 12 can be passed to and thereby shared with a number of wireless mobile terminal devices using, for example, a detachable small memory. This makes it possible a user to use data which is obtained and accumulated by other terminal devices in a new terminal device.

When users moves in the same area, the database can be efficiently constructed by sharing data that the users collect.

The memory controller 23 controls storing records into the memory 12, and specifically stores a record containing wireless communication system type data and the associated position data into the memory 12 with predetermined timings. For the above, the memory controller 23 serves to function as an example of a memory controller that autonomously and sequentially stores the position data of the wireless mobile terminal device 10 and the wireless communication system type data or the relation data into the memory in association with each other.

A timing of autonomously and sequentially storing is exemplified by: when the wireless mobile terminal device 10 captures and gains a communication system due to handover; when a predetermined time elapsed from storing the communication system (periodically storing the communication system); when the wireless mobile terminal device 10 accesses to a communication system for registering a position or for connection.

The system kind retriever 24 retrieves, on the basis of position data of the wireless mobile terminal device 10, a communication system associated with the position data. Specifically, the system kind retriever 24 serves to function as an example of a wireless communication system type data retriever that selects, upon receipt of current position data representing the current position of the wireless mobile terminal device 10, wireless communication system type data of the current position of the wireless mobile terminal device 10 or relation data related to the wireless communication system type data of the current position through adaptive retrieval of a plurality of pieces of the position data and a plurality of pieces of the wireless communication system type data or the relation data in association with each other, which are autonomously and sequentially stored by the memory controller and which are accumulated in the memory.

Specifically, the system kind retriever 24 calculates a distance Dn between the current position represented by the latitude and the longitude (here, the latitude is represented by X (−90≦X≦90), and the longitude is represented by Y (−180≦Y≦180)) of the wireless mobile terminal device 10 and the position where each record accumulated in the memory 12 and which is represented by the latitude and the longitude (here, the latitude is represented by Xn (−90≦Xn≦90), and the longitude is represented by Yn (−180≦Yn≦180), and n=1, 2, 3, . . . , N (here, N represents the total number of records in the memory))

The distance Dn can be calculated by, for example, following Expression (1).

Dn=\sqrt{(X−Xn)²−(Y−Yn)²} (1)

Any unit can be used for the current position and a position where each record in the database is obtained so long as a common unit is used because it is sufficient to confirm the closeness between the current position and a point where each record in the database is obtained.

The system kind retriever 24 gives a communication system associated with a smaller (i.e. closer to the current position) Dn (n=1, 2, 3, . . . , N) calculated from above Expression (1) a higher preference of a communication system to be selected by the wireless mobile terminal device 10.

In the example of FIG. 3, assuming that the wireless mobile terminal device 10 is currently present at a position (35.71, 149.53), preferences of communication systems are determined in the order of WiMAX>CDMA>LTE.

On the basis of the determined preferences, the system selecting module 25 attempts to gain a communication system in the order of WiMAX, CDMA, and LTE. A base station of each communication system is obtained in a manner defined under the standard of the communication system.

If any communication system is not obtained (gained) even after attempts, which end in failure, the system selecting module 25 again continues to make attempts based on the above preferences until a communication system is obtained. To save the consumption power of the wireless mobile terminal device 10, the intervals of the attempt may be gradually prolonged.

When no record is accumulated in the memory 12 because, for example, the wireless mobile terminal device 10 is powered for the first time, the system selecting module 25 attempts to obtain a communication system in preference order determined in advance. Besides, when the wireless mobile terminal device 10 is waiting in a particular communication system, the system selecting module 25 stores the type of the communication system and the associated position data into the memory 12.

Here, the LCD 19 of FIG. 1 displays the contents of each record accumulated in the memory 12 to the user of the wireless mobile terminal device 10. The LCD 19 serves to function as an example of a first monitor that displays the position data of the wireless mobile terminal device 10 and the wireless communication system type data or the relation data, which are accumulated in the memory; or a second monitor that displays the wireless communication system type data or the relation data on a map corresponding to the associated position data of the wireless mobile terminal device 10 which are accumulated in the memory.

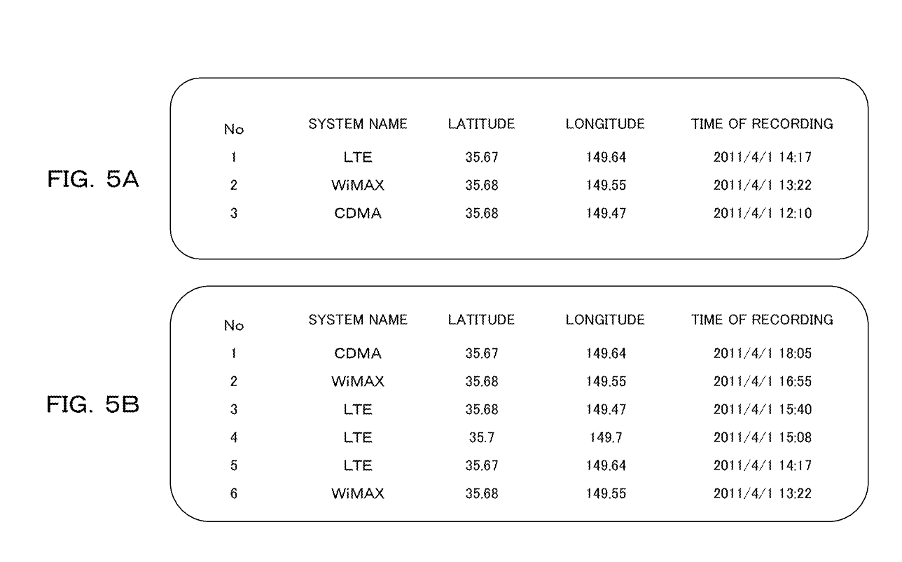

FIGS. 5A and 5B are diagrams illustrating examples of displaying on the LCD 19.

FIG. 5A is a diagram illustrating an example of displaying at a certain time, and after a time further elapses, an increased number of records are stored in the memory 12, so that the LCD 19 displays records as depicted in FIG. 5B.

It is possible to improve the usability of the displaying by converting the position data in the latitudes and longitudes into place names.

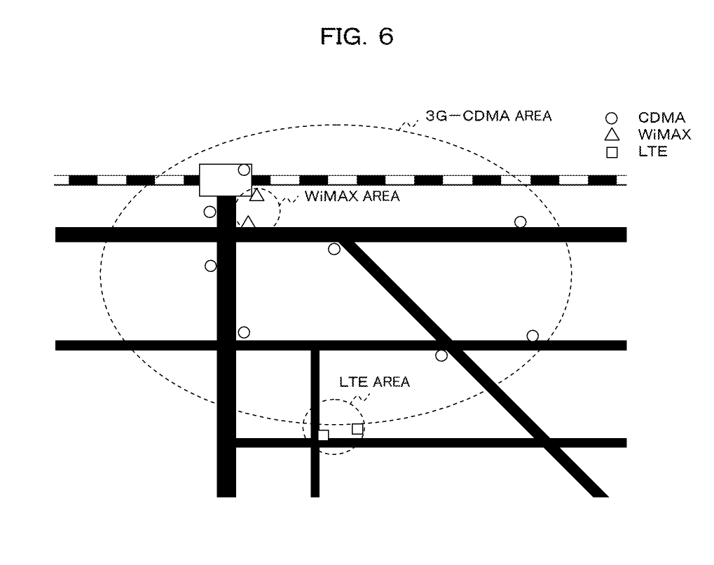

As illustrated in FIG. 6, displaying the accumulated record on the map makes the user possible to visually grasp areas providing a communication system that the user desires, and additionally easier to move to the area providing the desired communication system.

As depicted in the broken line of FIG. 6, areas in which respective system service can be used are estimated on the basis of the arrangement of the accumulated records, so that the user can intuitively grasp areas providing communication systems.

Additionally, by displaying time data on the map, the user can chronologically confirm the movement history of the wireless mobile terminal device 10.

The map data may be previously stored in the memory 12 when the wireless mobile terminal device 10 is shipped from the factory or may be downloaded into the memory 12 when the wireless mobile terminal device 10 makes an access to a predetermined communication system.

The system selecting module 25 gains a communication system using the preferences obtained by the system kind retriever 24. For this purpose, the system selecting module 25 is connected to the CDMA protocol module 27, the WiMAX protocol module 28, and the LTE protocol module 29.

Alternatively, the preferences obtained by the system kind retriever 24 may be temporarily stored in a system preference table 26 included in the memory 12, and the system selecting module 25 may obtain data of the preferences of communication systems by referring to the system preference table 26.

(1.2) A Succession of Procedural Steps of Selecting a Communication System in the Wireless Mobile Terminal Device:

Hereinafter, description will now be made in relation to a succession of procedural steps of selecting a communication system in the wireless mobile terminal device 10.

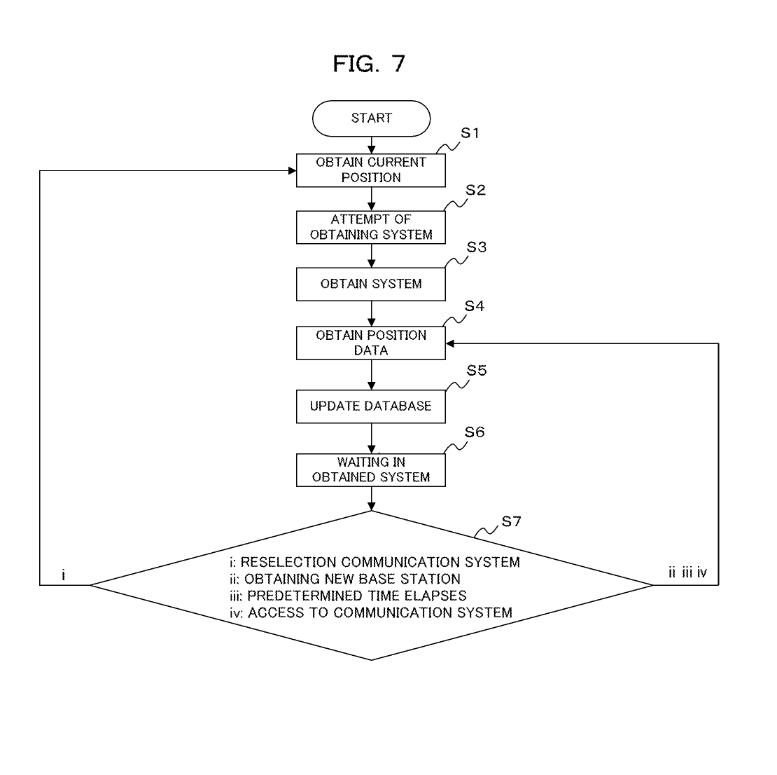

FIG. 7 is a flow diagram denoting a succession of procedural steps of selecting a communication system of the wireless mobile terminal device.

The wireless mobile terminal device 10 starts selection of a communication system when the wireless mobile terminal device 10 is powered on (also when the device 10 is wireless lost (out of service area), when communication finishes, and when a predetermined time elapses from storing a record.

First of all, the position data detector 21 obtains the current position data representing the current position of the wireless mobile terminal device 10 (Step S1).

Next, the system kind retriever 24 sets higher preferences to closer communication systems accumulated in the memory 12 to the current position, and the system selecting module 25 attempts to obtain a communication system using the preferences (Step S2). If the memory 12 accumulates no record when, for example, the wireless mobile terminal device 10 is powered for the first time, the system selecting module 25 attempts to obtaining a communication system in preferential order programmed in advance.

The system selecting module 25 obtains a communication system (Step S3).

Next, the position data detector 21 obtains the current position data (Step S4).

Then the system kind data detector 22 detects data of the communication system obtained in step S3 as wireless communication system type data. The memory controller 23 stores the wireless communication system type data detected by the system kind data detector 22 and the position data detected by the position data detector 21 in Step S4 into the memory 12 in association with each other, so that the contents accumulated in the memory 12 is updated (Step S5).

The wireless mobile terminal device 10 waits in the obtained system (step S6).

If a communication system is to be reselected because of wireless lost, finish of communication, or predetermined time elapsing (Route i in Step S7), the procedure moves to Step S1.

Conversely, if a base station not registered is gained due to handover (Route ii in Step S7), the procedure moves to Step S4 to update the contents in the memory 12.

If a predetermined time elapses from previous obtaining a system (Route iii in Step S7), the procedure moves to step S4.

Furthermore, if the wireless mobile terminal device 10 makes an access to a communication system for position registration or connection (Route iv in Step S7), the procedure moves to step S4.

Namely, the succession of procedural steps of selecting a communication system of the wireless mobile terminal device of FIG. 7 includes: detecting position data representing a position of the wireless mobile terminal device; detecting the wireless communication system type data representing a wireless communication system being used by the wireless mobile terminal device or relation data related to the wireless communication system type data; autonomously and sequentially storing the position data and the wireless communication system type data or the relation data into a memory included in the wireless mobile terminal device in association with each other; and upon receipt of current position data representing a current position of the wireless mobile terminal device, selecting wireless communication system type data of the current position of the wireless mobile terminal device or relation data related to the wireless communication system type data of the current position through adaptive retrieval of a plurality of pieces of the position data and a plurality of pieces of the wireless communication system type data or the relation data in association with each other, which are autonomously and sequentially stored in the memory.

In the above example, the procedural steps of FIG. 7 starts from Step S1. Alternatively, the procedure may start from Step S4.

According to the above configuration, the wireless mobile terminal device 10 autonomously and sequentially stores data related to an available communication system and the position data into the memory 12, and adaptively retrieves, from the memory 12, a communication system that is to be used on the basis of the position data according to the requirement, so that the communication system to be used can be efficiently selected.

This configuration allows the user to access an appropriate communication system rapidly.

In addition, since the time for system search can be reduced, it is possible to save the consumption power of the wireless mobile terminal device 10.

(2) Others:

Each element and each function of the above wireless mobile terminal device 10 may be omitted according to requirement and may be appropriately combined so as to satisfy the functions of the present invention.

The functions of the position data detector 21, the system kind data detector 22, the memory controller 23, the system kind retriever 24, the system selecting module 25, the CDMA protocol module 27, the WiMAX protocol module 28, the LTE protocol module 29, and the GPS module 30 of the first embodiment are achieved by a computer executing a control program. The control program instructs the computer to execute: autonomously and sequentially storing position data of a wireless mobile terminal device capable of using two or more wireless communication systems and wireless communication system type data representing a wireless communication system being used by the wireless mobile terminal device or relation data into a memory included in the wireless mobile terminal device; and upon receipt of current position data representing a current position of the wireless mobile terminal device, selecting wireless communication system type data of the current position of the wireless mobile terminal device or relation data related to the wireless communication system type data of the current position through adaptive retrieval of a plurality of pieces of the position data and a plurality of pieces of the wireless communication system type data or the relation data in association with each other, which are autonomously and sequentially stored in the memory.

For example, the above control program is provided in the form of being stored in a computer-readable recording medium such as a flexible disk, a CD (e.g., CD-ROM, CD-R, and CD-RW), a DVD (e.g., DVD-ROM, DVD-RAM, DVD-R, DVD+R, DVD-RW, DVD+RW and HD DVD), Blu-ray disk, a magnetic disk, an optical disk, and a magneto-optical disk. The computer reads the program from the recording medium and stores the program into an internal or external memory for future use. The program may be stored in a storage device (recording medium), for example, a magnetic disk, an optical disk, and magneto-optical disk, and may be provided to a computer from the storage device through a communication route.

Here, a computer is a concept of a combination of hardware and an OS and means hardware which operates under control of the OS. Otherwise, if an application program operates hardware independently of an OS, the hardware corresponds to the computer. In the first embodiment, the CPU 11 serves to function as a computer.

The above first embodiment assumes that the wireless mobile terminal device 10 includes three modules of the CDMA protocol module 27, the WiMAX protocol module 28, and the LTE protocol module 29, which are of course exemplary. There is no intention to restrict the type and the number of available communication systems. For example, the first embodiment is also applied to a case where another communication system such as Wi-Fi is used and a case where two, four or more communication systems are used.

If the wireless mobile terminal device 10 uses more communication systems, the first embodiment can efficiently searching for a system and can therefore expect more beneficial effect.

The first embodiment assumes that the wireless communication system type data and the position data are stored into the memory 12 in association with each other. Alternatively, the wireless communication system type data can be replaced by relation data related to the wireless communication system type data.

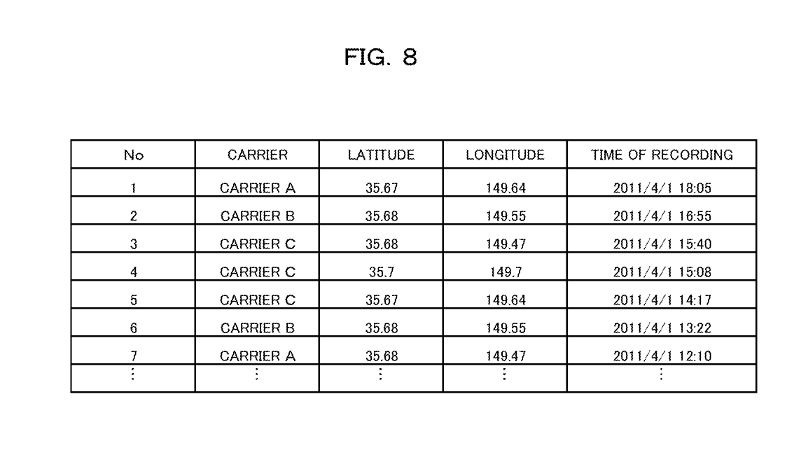

For example, as illustrated in FIG. 8, data of a carrier that provides a communication service and position data may be stored in the memory 12 in association with each other.

Thereby, the user can efficiently select one or more communication services available at the current position.

A carrier receives data of a carrier and the associated position data from a user and thereby precisely grasps a service area that users actually use the communication service. This can eliminate the requirement of the carrier to check service areas.

The first embodiment can be applied to, serving as the wireless mobile terminal device 10, any mobile terminal device that can use two or more wireless communication systems and that is exemplified by a cell phone (e.g., a feature phone or a smartphone), a portable media player, and a portable game console.

Furthermore, the first embodiment can be also applied to a user terminal, such as a personal computer, connected to a communication device such as a cell phone or a data communication card.

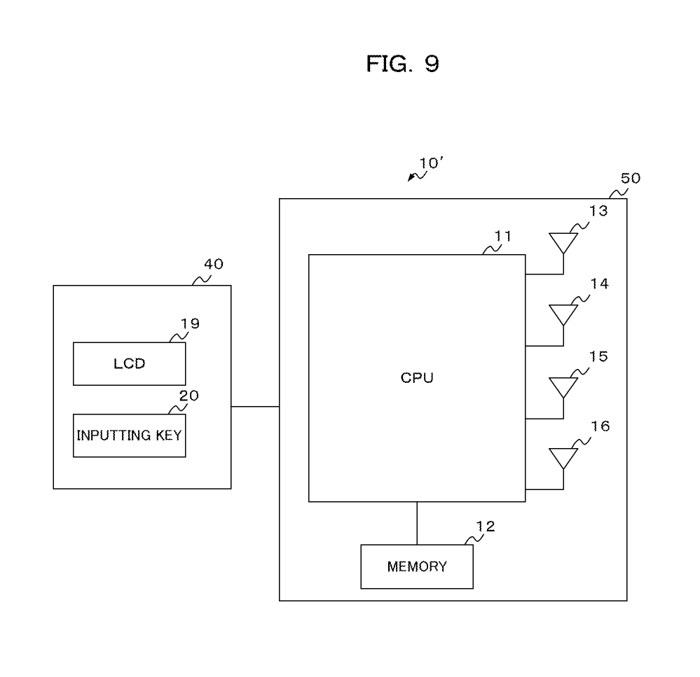

FIG. 9 is a diagram schematically illustrating an example of the hardware configuration of a wireless mobile terminal device 10′ according to a first modification to the above first embodiment. In FIG. 9, elements and functions represented by reference numbers explained above have the same or the substantially same elements or functions. So, repetitious description is omitted here.

A user terminal 40 for example, communicates through a communication device 50 set in a USB terminal and a dedicated slot of the user terminal 40.

In the example of FIG. 9, the user terminal 40 includes the LCD 19 and the inputting key 20; and the communication device 50 includes the CPU 11, the memory 12, and the receiving antennas 13-16.

The entire configuration of FIG. 9 may be collected in the data communication card 40 by including the LCD 19 and the inputting key 20 of the user terminal 40 into the communication device 50.

Alternatively, each component of the communication device 50 of FIG. 9 may be included in the user terminal 40.

Part of the functions achieved by the CPU 11 of the communication device 50, i.e., the functions of the position data detector 21, the system kind data detector 22, the memory controller 23, the system kind retriever 24, the system selecting module 25, the system preference table 26, the CDMA protocol module 27, the WiMAX protocol module 28, the LTE protocol module 29, and the GPS module 30, may be included in the user terminal 40.

In this case, since part of processing of the communication terminal can be performed by the user terminal 40, resultant reduction in processing load on the communication device 50 contributes to high-speed processing and small circuit size of the communication device 50.

The technique disclosed here can provide a wireless communication terminal device efficiently selects a wireless communication system.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A wireless mobile terminal device capable of using two or more wireless communication systems, comprising:
a position data detector that detects position data representing a position of the wireless mobile terminal device;
a wireless communication system type data detector that detects wireless communication system type data representing a wireless communication system being used by the wireless mobile terminal device or relation data related to the wireless communication system type data;
a memory that accumulates the position data detected by the position data detector and the wireless communication system type data or the relation data detected by the wireless communication system type data detector in association with each other;
a memory controller that autonomously and sequentially stores the position data and the wireless communication system type data or the relation data into the memory; and
a wireless communication system type data retriever that selects, upon receipt of current position data representing a current position of the wireless mobile terminal device, wireless communication system type data of the current position of the wireless mobile terminal device or relation data related to the wireless communication system type data of the current position through adaptive retrieval of a plurality of pieces of the position data and a plurality of pieces of the wireless communication system type data or the relation data in association with each other, which are autonomously and sequentially stored by the memory controller and which are accumulated in the memory.

2. The wireless mobile terminal device according to claim 1, wherein the memory controller is configured to autonomously and sequentially store the position data and the wireless communication system type data or the relation data into the memory when the wireless mobile terminal device is waiting in a wireless communication system being unknown or being switched, or when a predetermined time elapses from storing of the wireless communication system.

3. The wireless mobile terminal device according to claim 2, wherein the wireless communication system being unknown or being switched is a wireless communication system not represented by the wireless communication system type data or the relation data accumulated in the memory.

4. The wireless mobile terminal device according to claim 1, wherein the wireless communication system type data retriever is configured to retrieve, upon receipt of the current position data of the current position of the wireless mobile terminal device, the wireless communication system type data of the current position of the wireless mobile terminal device or relation data related to the wireless communication system type data of the current position by:
calculating a distance between the current position and each position of the position represented by the position data accumulated in the memory;
determining, on the basis of a result of the calculating, a preference of each wireless communication system in the order of a shorter distance between the current position and a position associated with the wireless communication system type data or the relation data; and
retrieving, on the basis of a result of the determining, the wireless communication system type data of the current position of the wireless mobile terminal device or the relation data related to the wireless communication system type data of the current position.

5. The wireless mobile terminal device according to claim 4, wherein the current position data is input into the wireless mobile terminal device when the wireless mobile terminal device is powered, when communication of the wireless mobile terminal device finishes, or when the wireless mobile terminal device shifts from a no-service-area state into a waiting state.

6. The wireless mobile terminal device according to claim 1, further comprising: a first-powering wireless communication system type data retriever that retrieves, on the basis of a predetermined preference, the wireless communication system type data or the relation data prior to the retrieval of the wireless communication system type data retriever when the wireless mobile terminal device is powered for the first time.

7. The wireless mobile terminal device according to claim 1, wherein the position data detector selectively detects position data included in notification data which the wireless mobile terminal device receives from the wireless communication system being used by the wireless mobile terminal device or position data obtained by means of a Global Positioning System.

8. The wireless mobile terminal device according to claim 1, wherein the memory further stores a time when the position data and the wireless communication system type data or the relation data are stored in the memory in association with one another.

9. The wireless mobile terminal device according to claim 1, further comprising a first monitor that displays the position data of the wireless mobile terminal device and the wireless communication system type data or the relation data, which are accumulated in the memory.

10. The wireless communication terminal device according to claim 1, further comprising a second monitor that displays the wireless communication system type data or the relation data on a map corresponding to the associated position data of the wireless mobile terminal device.

11. The wireless mobile terminal device according to claim 9, wherein the first monitor displays a time when the position data and the wireless communication system type data or the relation data are stored in the memory along with the position data and the wireless communication system type data or the relation data.

12. A method for retrieving wireless communication system type data in a wireless mobile terminal device capable of using two or more wireless communication systems, the method comprising:
detecting position data representing a position of the wireless mobile terminal device;
detecting the wireless communication system type data representing a wireless communication system being used by the wireless mobile terminal device or relation data related to the wireless communication system type data;
autonomously and sequentially storing the position data and the wireless communication system type data or the relation data into a memory included in the wireless mobile terminal device in association with each other; and
upon receipt of current position data representing a current position of the wireless mobile terminal device,
selecting wireless communication system type data of the current position of the wireless mobile terminal device or relation data related to the wireless communication system type data of the current position through adaptive retrieval of a plurality of pieces of the position data and a plurality of pieces of the wireless communication system type data or the relation data in association with each other, which are autonomously and sequentially stored in the memory.

13. A computer-readable recording medium having stored therein a program for instructing a computer to execute a process comprising:
autonomously and sequentially storing position data of a wireless mobile terminal device capable of using two or more wireless communication systems and wireless communication system type data representing a wireless communication system being used by the wireless mobile terminal device or relation data into a memory included in the wireless mobile terminal device in association with each other; and
upon receipt of current position data representing a current position of the wireless mobile terminal device,
selecting wireless communication system type data of the current position of the wireless mobile terminal device or relation data related to the wireless communication system type data of the current position through adaptive retrieval of a plurality of pieces of the position data and a plurality of pieces of the wireless communication system type data or the relation data in association with each other, which are autonomously and sequentially stored in the memory.
